(19) United States
(12) Patent Application Publication
(10) Pub. No.: US 2005/0273599 A1
(43) Pub. Date: Dec. 8, 2005

(54) Embedding identification data into a work

(76) Inventors: Rajesh B. Khandelwal, Bridgewater, NJ (US); Robert Fish, Princeton, NJ (US)

Correspondence Address: HARNESS, DICKEY & PIERCE, P.L.C., P.O. BOX 828, BLOOMFIELD HILLS, MI, 48303, US

(21) Appl. No.: 10/863,807

(22) Filed: Jun. 8, 2004

(51) Int. Cl. H04L 9/00

(52) U.S. Cl. 713/160; 358/526

(57) ABSTRACT

A method for deterring or detecting the unauthorized dissemination or copying of a work is presented. Personal identification data is embedded into a work before the work is sent over a communication link to a receiver. The work is sent over the communication link to the receiver.

### FIELD OF THE INVENTION

The present invention relates to embedding identification data into a work. More specifically, the invention relates to embedding personalized identification data into a work before the work is presented to a user.

### BACKGROUND OF THE INVENTION

One of the most significant concerns for a business or person that owns or distributes a creative work (e.g. a movie, a sound recording etc.) involves the ease of unauthorized dissemination of the work over a network. Presently, an unscrupulous person can email a file that contains the movie to another person. Alternatively, an unscrupulous person may post the movie on a web site for others to download.

Businesses that distribute audiovisual works or sound recordings lose millions of dollars on an annual basis due to unauthorized copying or dissemination of these works. It is therefore desirable to have a mechanism that addresses this problem.

### BRIEF DESCRIPTION OF THE DRAWINGS

The present invention will become more fully understood from the detailed description and the accompanying drawings, wherein:

FIG. 1A is a block diagram of a system that transfers a work that includes personalized identification data from a distributor to a receiver in accordance with one embodiment of the invention;

FIG. 1B is a block diagram of a system that transfers a work that includes personalized identification data from a distributor to a receiver in accordance with one embodiment of the invention;

FIG. 1C is a block diagram of a system that transfers a work that includes personalized identification data from a distributor to a receiver in accordance with one embodiment of the invention;

FIG. 2 is a block diagram illustrating an analog cable network for transferring a work from a business to a receiver in accordance with one embodiment of the invention;

FIG. 3 is a block diagram illustrating a digital cable network for transferring a work from a business to a receiver in accordance with one embodiment of the invention;

FIG. 4 is a schematic diagram of a receiver in accordance with one embodiment of the invention;

FIG. 5 is a schematic diagram of a receiver architecture in accordance with one embodiment of the invention;

FIG. 6 is a schematic diagram of a receiver in accordance with one embodiment of the invention;

FIG. 7A is a schematic diagram of a personalized screen in accordance with one embodiment of the invention;

FIG. 7B is a schematic diagram of a personalized screen in accordance with one embodiment of the invention; and

FIG. 8 is a flow diagram of one method of embedding personalized identification data into a work before the work is presented to a user of a device that receives the work in accordance with one embodiment of the invention.

### DETAILED DESCRIPTION OF THE PREFERRED EMBODIMENTS

Techniques of the invention help to deter or detect the unauthorized copying or dissemination of a creative work such as a movie. This is accomplished, in part, by embedding personalized identification data into the work before it is sent over a communication link between a distributor of the work and a receiver. A work is created when data is fixed in a copy such as a storage medium. Additionally, a work includes an audiovisual work (e.g., video, movie, cartoon, computer game), an audio work (e.g., sound recording), and a visual work (e.g., picture).

Another embodiment of the invention involves personalized identification data that is automatically embedded into work after the receiver obtains the work from the distributor. By embedding personalized identification data into a work, unauthorized copying or dissemination of the work may be tracked to the individual who received the authorized copy of the work.

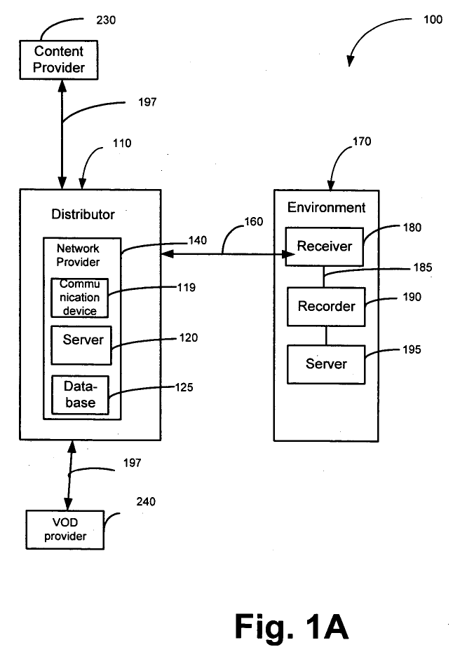

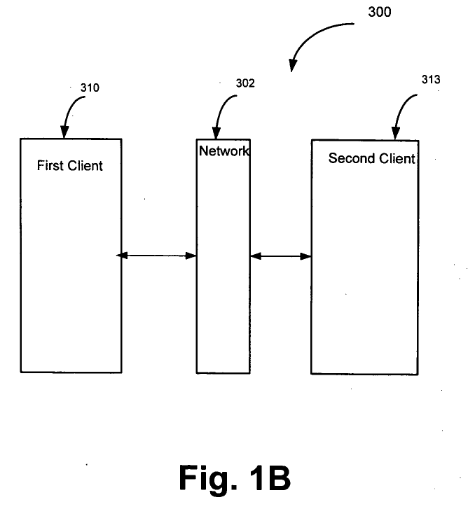

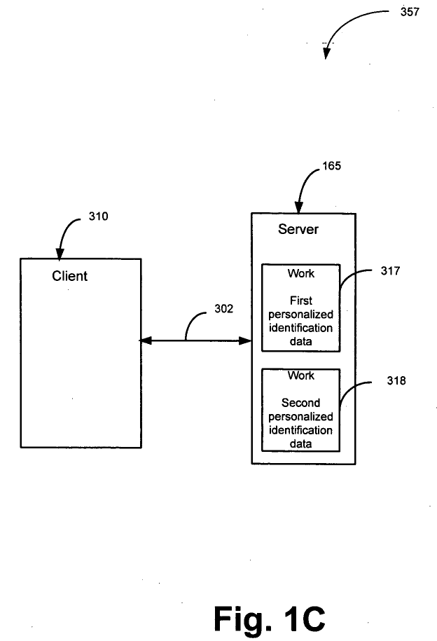

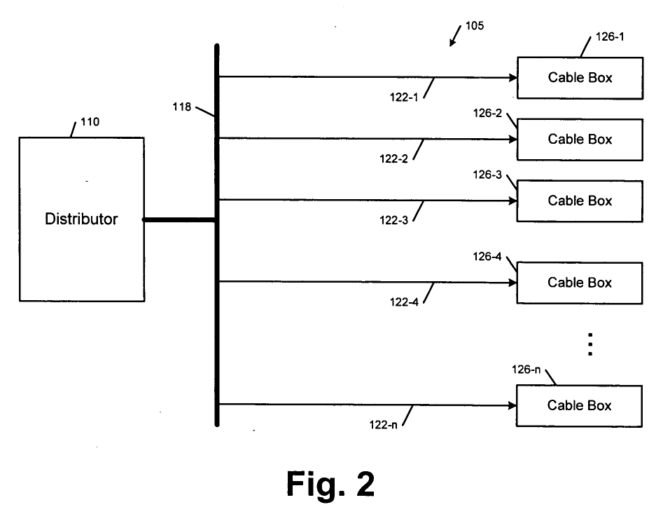

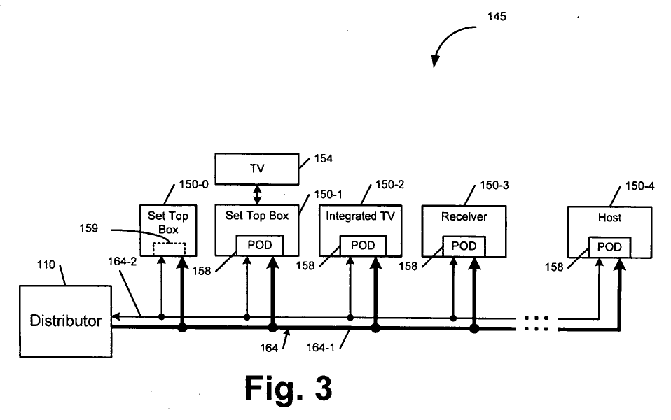

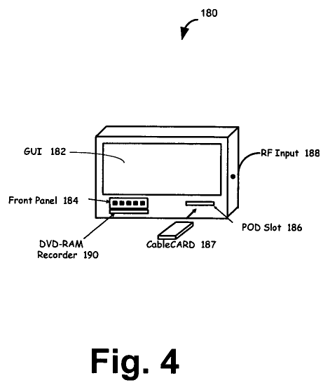

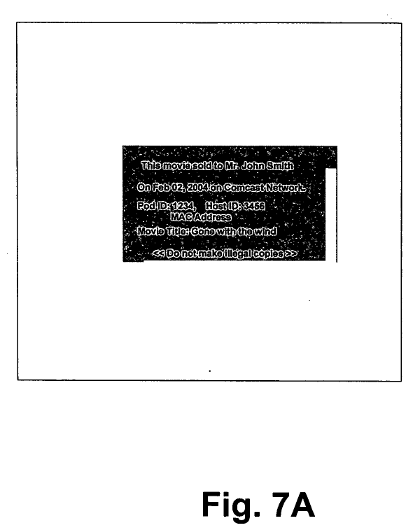

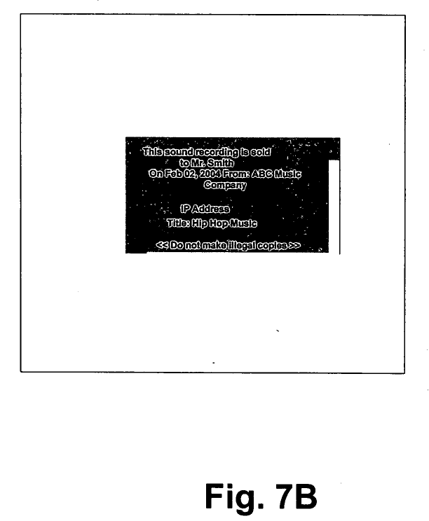

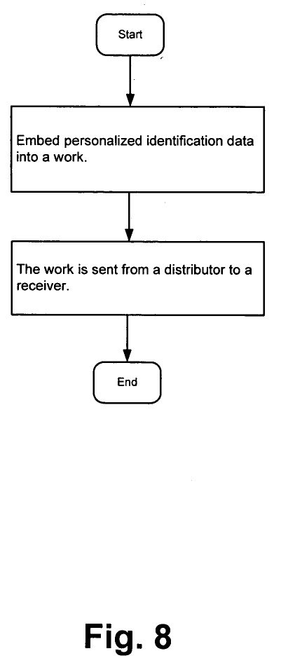

Presented below is a description of systems that are used to generate and embed personalized identification data into a work before sending the work over a wireless or a wired communication link relative to FIG. 1A-1C. FIGS. 2-3 illustrate wired communication links that may be used to send a work from a distributor to a receiver. FIGS. 4-6 illustrate a receiver that may be used to transfer personalized identification data to a distributor of a work and to receive the work. FIGS. 7A-7B illustrate personalized identification data. FIG. 8 illustrates one method of embedding personalized identification data into a work. The following description of the preferred embodiments is merely exemplary in nature and is in no way intended to limit the invention, its application, or uses.

FIG. 1A is a block diagram of a system 100 that is used to generate and embed personalized identification data in a work presented to a user. The system 100 includes a distributor 110, an environment 170, a network 197, a supplier 230, and a VOD provider 240. Each component is described below.

The distributor 110 owns or is able to license at least one copy of a work to a user. The scope of the definition of the distributor 110 includes a network provider 140. The network provider 140 communicates services (e.g., cable services, video-on-demand services, etc.) or products to a receiving device 180 over a communications link 160. The network provider 140 includes cable companies, telephone companies, Internet service providers, satellite companies, or other suitable businesses. The network provider 140 includes communication device 119, the server 120, and the database 125. The communication device 122 is a head-end, a satellite, or other like device capable of communicating a work to the receiver 180. In one embodiment, the network provider 140 is configured to receive data over the communication link 160 that is sent from the receiver 180. Alternatively, the network provider 140 polls the receiver 180 for this data. Polling for data is a form of requesting or checking for information from a device such as the receiver 180.

The data that may be received from the receiver 180 may relate to the receiver 180 itself or to a user of receiver 180. This data is then used to generate personalized identification data that is embedded into a work. Generating the personalized identification data may involve taking a portion or all of the data that is obtained from the receiver 180.

The personalized identification data then is embedded into a work as a watermark or through another suitable mark. One method of generating and embedding personalized identification data into a work is described relative to FIG. 8. Skilled artisans understand, however, that numerous conventional methods may be used to generate and embed personalized identification data such as a watermark into a work.

The server 120 controls various operations associated with transferring a work to the receiver 180. For example, the server 120 is configured to access a database 125 to link the correct billing information (e.g., name of the consumer, billing address, cost of services for a month, etc.) of a user of the receiver 180 in order to properly bill (or sell) a work that is transferred to the receiver 180. In one embodiment, the server 120 may also store billing information in the database 125 such as whether the work was sold or rented to a user of the receiver 180. Additionally, the server 120 may generate and embed personalized identification data into a work and then transfer the work to the network provider 140.

The network provider 140 transfers a work over a communication link 160 from distributor 110 to a receiver 180. The communication link 160 may be an analog cable network 105 illustrated in FIG. 2, a digital cable network illustrated in FIG. 3, the Internet, or some other suitable network that is able to transfer a work from distributor 110 to receiver 180. The analog cable network 105 includes a distributor 110 which generates cable signals over a cable 118. Cable drops 122-1, 122-2, . . . , and 122-n provide the cable signals to cable boxes 126-1, 126-2, . . . , and 126-n at customer locations.

Alternatively, the work may be transferred over a digital cable network 145 and channels as shown in FIG. 3 by using an OpenCable™ which is a standard that has been defined by cable operators to provide digital cable-ready devices using a common platform. In this embodiment, the distributor 110 is coupled to the set-top box (STB) 150-0, the point of deployment (POD) module 158 of STB 150-1, an integrated TV 150-2, a receiver 150-3, and a host 150-4 through an in-band channel 164-1 and an out-of-band channel 164-2 over a cable 164. A POD module 158, which is removable from these devices, provides security and user authentication. Typically, the POD module 158 is provided by the distributor 110 and is implemented using a POD card. Alternatively, security component 159, embedded into the STB 150-0, performs security and user authentication.

The POD card could be configured to store personalized identification data associated with a user or receiver 180. The POD module 158 communicates this data as well as other data with the distributor 110 using an in-band channel 164-1 and/or an out-of-band (OOB) channel 164-2 over the cable 164 to a distributor 110. Alternatively, the POD module 158 passes data to the devices such as an STB 150-1, an integrated TV 150-2, a receiver 150-3, or a host 150-4. In this scenario, these devices are able to generate and embed personalized identification data into a work before the work is presented to a user, as described relative to FIG. 8. The STBs 150-0 and 150-1, the receiver 180, the integrated TV 150-2, and the host 150-4 are described in greater detail below.

The STBs 150-0 and 150-1 are electronic devices that are connected to a communication channel and produce output on a conventional television screen. The STB 150-1 is commonly used to receive and decode digital television broadcasts and to interface with a network such as the Internet through the user's television or monitor 154 instead of a PC. The STB 150-1 fall into several categories, from the simplest that receive and unscramble incoming television signals to the more complex that function as multimedia desktop computers that can run a variety of advanced services such videoconferencing, home networking, IP telephony, VOD, games, and high-speed Internet TV services.

The integrated TV 150-2 includes a STB. The STB operates in the same fashion as the STB 150-1. Host 150-4 is an STB or a receiver configured to store and to execute an application such as the OpenCable™ Application Platform implementation.

FIGS. 4-6 are schematic diagrams of a receiver which illustrates the recorder 190 integrated into a receiver 180. The recorder 190 stores the work into a storage medium. The receiver 180 also includes a graphical user interface (GUI) 182, a front panel 184, a POD slot 186 configured to receive a POD card 187 (or other suitable cards such as SMART cards, etc.), and a radio frequency (RF) input 188.

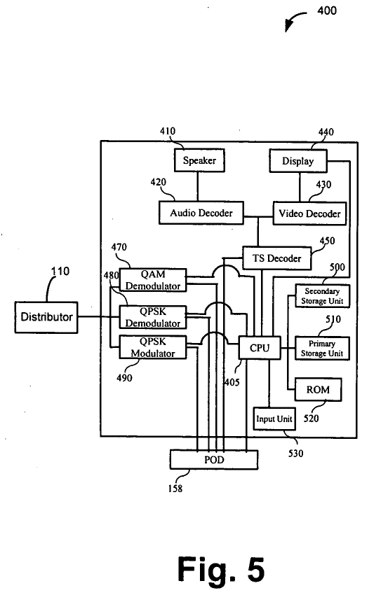

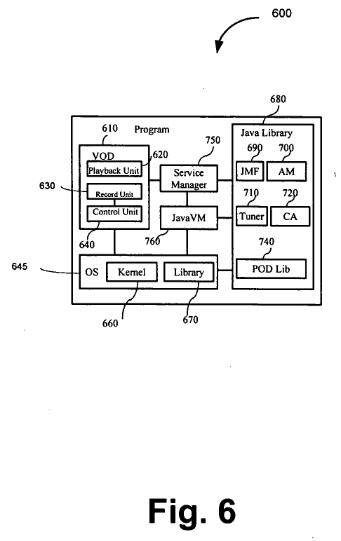

FIGS. 5 and 6 illustrate details of a receiver 400 that is able to communicate with the network provider 140. The receiver 400 is configured to send personalized identification data to a distributor 110 and receive the work from a distributor 110. The receiver 400 is also configured to generate and embed personalized identification data into the work.

FIG. 5 is a receiver 400 such as an integrated cable receiver architecture in accordance with one embodiment of the invention. The receiver 400 includes a speaker 410, an audio decoder 420, a video decoder 430 connected to display 440, a transport stream (TS) decoder 450, a recorder 460 such as a DVD-RAM recorder, a CPU 405, secondary (SEC) storage unit 500, a primary (PRI) storage unit 500, a read only memory (ROM) 520, input units 530, a POD module 158, a QUAM demodulator 470, a quadrative phase shift keying (QPSK) demodulator 480, a TPSK modulator 490, and a TS decoder 450. These components, described below, cooperate to transfer data such as personalized identification data to the distributor 110. These components also are configured to receive and present the work to a user of the receiver 400. Each component is now briefly described.

The audio decoder 420 connects the audio data embedded in an MPEG-2 transport stream packets passed by the TS decoder 450 and outputs the connected data after digital-analog conversion to the speaker 507. The speaker 507 outputs audio signals passed by the audio decoder 420.

The video decoder 430 connects the video data embedded in the MPEG-2 transport stream packets passed by the TS decoder 450 and outputs the data after digital-analog conversion to the display 440. The display 440 is used to output video signals passed by the video decoder 430 and display messages specified by the CPU 405. The display 440 shows the personalized identification data to a user of a receiver 400. The display 440 may be, for example, a plasma display, a field emission display (FED), a cathode ray tube (CRT), or a liquid crystal display (LCD).

The secondary storage unit 510 includes, for example, flash memory and a hard disk, in which data, works, and programs specified by a CPU 405 are saved and/or erased. Data such as personalized identification data and programs saved in the secondary storage unit 510 are referred to by the CPU 405, and are kept in the secondary storage unit 510 after the receiver 400 is powered off. The primary storage unit 500 includes, for example, read access memory (RAM), in which data and programs specified by the CPU 405 are temporarily saved and/or erased.

The ROM 520 is a non-rewritable memory device including, for example, ROM, CD-ROM, and DVD and stores programs executed by CPU 405. The input unit 530 includes, for example, a front panel and/or a remote control that accepts user input.

FIG. 6 is a receiver 600 such as an integrated cable receiver in accordance with one embodiment of the invention. The program 600 includes the VOD 610, the operating system (OS) 645, the JAVA library 680, the service manager 750, and the JavaVM 760. Each of these components is now described in greater detail.

The VOD 610 includes the playback unit 620, the recording unit 630 and the control unit 640. The playback unit 620 allows the VOD 610 to be viewed on the display 440. The recording unit 630 allows the VOD 610 to be recorded onto a separate recording medium such as a CD, a DVD, or video. The control unit 640 controls the functionality associated with the playback unit 620 and the record unit 630. The control unit 640 also determines when to generate and to embed personalized identification data into a work. Once the control unit 640 determines that the personalized identification data is to be generated, the control unit 640 embeds the personalized identification data into the work using conventional techniques. Embedding the personalized identification data into a work occurs before the work is presented to a user. In one embodiment, the control unit 640 does not activate the playback unit 620 until the personalized identification data is embedded into the work.

The OS 645 includes the kernel 660 and the library 670. The OS 645 is a subprogram such as Linux that is booted up by the CPU. In this embodiment, the kernel 660 of OS 645 executes the control unit 640 and JavaVM 1203 as subprograms, while the library 670 provides these subprograms with multiple functions for controlling the components of the receiver 400.

The service manager 750 sends a channel identifier to the AM 700 within the Java library 680 and asks for data broadcast playback, which means extracting a Java program included in an MPEG-2 transport stream and making JavaVM 760 execute it. The JAVA library 680 includes the JMF 690, the AM 700, the tuner 710, the CA 720, the DVD library 730 and the POD library 740.

The Java virtual machine (JavaVM) 760 then sequentially analyzes and executes programs written in the Java™ language. A Java virtual machine is an interpreter to execute this byte code. The JavaVM 760 is started by the kernel 660 which specifies a Java program that is to be executed. In this embodiment, the kernel 660 specifies the service manager 750 as a Java program to be executed.

The service manager 750 then sends the channel identifier to the tuner 710 contained in the Java library 680 and asks for tuning. The tuner 710 gets tuning information by referring to channel information stored in the secondary storage unit 500. The tuner 710 sends the tuning information through the library 670 in the OS 645 to the QAM demodulator 470, which demodulates signals sent from the network provider 140 in accordance with this tuning information and sends the demodulated signals to POD module 158.

The service manager 750 requests that the CA 720 to descramble the signals. The CA 720 gives information necessary for descrambling through the library 670 in the OS 645 to the POD 540, which descrambles the signals given by the QAM demodulator 470 according to the given information and passes the descrambled signals to the TS decoder 450.

The service manager 750 then provides the JMF 690 with the channel identifier, asking for the playback of audio and video. The JMF 690 specifies the packet ID and the CPU 405 to the TS decoder 450 through the library 670 in the OS 650 in order to get a PAT packet. The TS decoder 450 performs filtering using the packet ID and passes the PAT packets to CPU 405. The JMF 690 then collects the PAT packets.

The JMF 690 provides the TS decoder 450 through the library 670 of the OS 645 with a set of the audio packet ID and the audio decoder 506 as an output destination as well as the video packet ID and the video decoder 508 as an output destination. The TS decoder 450 performs filtering according to the provided packet IDs and output destinations. In this example, packets are sent to the audio decoder 506, and other packets to the video decoder 508. The audio decoder 506 converts those packets from digital to analog and plays audio using the speaker 507. The video decoder 508 converts the packets from digital to analog and displays video on the display 509.

Referring back to FIG. 1A, after receiving the work, the receiver 180 either presents the work to a user of the receiver 180 or sends the work to the recorder 190 to be stored. The copy is either stored in a storage medium on a temporary basis such as for twenty four hours or stored on a permanent basis. The copy stored for twenty four hours is disabled using a timer incorporated into the recorder 190 or other suitable mechanism. The recorder 190 may be a digital video diskette recorder, a random access memory (RAM) recorder, a video recorder, or other suitable recording device.

Connected to recorder 190 is a server 195. The server 195 controls various devices connected to a network such as a local area network (LAN). The server 195 controls software, access to peripherals and other parts of the network 185.

A content provider 230 is any party that provides a completed work to another party. For example, a video or DVD supplier such as Blockbuster is a content provider 230. The VOD provider 240 may be nCUBE, Concurrent, or other suitable business.

In addition to the network illustrated in FIG. 1A, techniques of the invention may be implemented through various other networks such as a peer-to-peer network (FIG. 1B), and a client/server network (FIG. 1C). The peer-to-peer network such as the system 300, represented in FIG. 1B, includes a first client 310, a network 302, a second client 313. The first and the second clients 310, 313 possess similar or the same capabilities. Either the first or the second client 310, 313 may initiate a communication over a network 302 with the other client. The network 302 may be a wide-area network (WAN), the Internet, or other suitable network.

The first and the second clients 310, 313 are computers (e.g., laptop computer, a personal digital assistant, a cellular phone or other like device) that are able to perform either wireless or wired communication to connect with the network 302. At least one of the first and the second clients 310, 313 generates and embeds the personalized identification data into a work before sending the work to the other client.

FIG. 1C represents a client/server network 357. In this embodiment, the server 165 generates and embeds personalized identification data into a work. Thereafter, the work is sent over the network 302 to the client 163. Additionally, server 165 includes two works 317, 318. The only difference between works relates to the personalized identification data. The work 317 includes a first personalized identification data whereas the work 318 includes a second personalized identification data. This system illustrates that a network provider 140 customizes the delivery of a work such as a movie provided through a VOD service embedding personalized identification data related, for example, to the user of the client 310.

FIG. 8 is a flow diagram of one method of embedding identification data into a work and sending the work from a distributor over a communication link to a receiver. The work may be an audiovisual work, an audio work, or a visual work (e.g., picture). At operation 800, a host such as an STB, a head-end, or other suitable device may be used to embed the personalized identification data into the work. In one embodiment, personalized identification data is embedded into an audiovisual work at operation 700 before sending the audiovisual work over a communication link from a distributor to receiver. The personal identification data may be in the form of a watermark (visible or hidden) or other suitable format. Typically the personalized identification data is encrypted using conventional techniques before it is embedded into a work.

There are numerous methods that may be used to embed personalized identification data into a visual media such as image, video, cartoon, cartoon character, or game etc. One such process of hiding identification data into visual media involves several operations. Identification data includes a watermark signal and other similar types of signals that identify the contents of the image file, the owner, and other such information (e.g., copyright information). The process includes a frequency domain masking operation, an edge-block detection operation, and an operation for identifying blocks adjacent to smooth region. These process operations analyze an image data with respect to three different block region types: a smooth block region, a texture block region, and an edge block region.

A smooth block region is defined as a uniform region with relatively low DCT coefficient values. A non-smooth block region is divided into a texture block region and an edge block region.

Undesirable artifacts are more likely to be revealed in an edge block than in a texture block due to the random artifacts tending to be disguised by a random structured pattern. A visual hiding process then attenuates preliminary embedability and just-noticeable-difference (JND) values via a process for each block which are computed during the aforementioned three operations. Embedability involves a coefficient able to be changed by a certain amount that is large enough to carry hidden data without causing visible artifacts, and the term just-noticeable difference (JND) is the amount of changes performed on a coefficient which is just on the level to be noticed. The embedability and JND values for each block are computed by the preliminary operation, i.e., the frequency mask operation which does not consider the ringing and/or other artifacts depending on the type of block region and are used to hide identification data.

The identification data that is personalized may be embedded in any location within the work. Typically, however, the personalized identification data is embedded at the beginning of the work. This ensures that the user who views the work sees a personalized screen. FIG. 7A illustrates a personalized screen that may be inserted into a work such as a movie prior to transferring the work to a user from the distributor 110. In this personalized screen, information is presented such as the title of the movie, the name of the person to whom the movie was sold such as to Mr. John Smith, the date of the sale which was on Feb. 2, 2004 from a particular business such as Comcast. A plurality of identifiers associated with a receiver such as a pod ID provided as 1234, a host ID such as 3456, a MAC address such as MM-MM-MM-SS-SS-SS, an Internet protocol address (i.e., a 32 bit numeric address), or other suitable information. The title of the movie is also included along with a notice that unauthorized copying of the video is prohibited by law. After the personalized identification has been embedded into the work using conventional techniques, the work is sent over a communications link 60.

FIG. 7B illustrates personalized identification data that may be embedded into an audio work such as sound recording. In this embodiment, the name of the user and a notice not to copy or disseminate the work is embedded into the work. This personalized identification data may be embedded anywhere in the work such as the beginning or at the end of the work.

At operation 820, the audiovisual work is sent from the distributor to the receiver. In another embodiment, the personalized identification data is embedded into the work before being presented to a user of a receiver, a television, a computer, stereo, player, or other suitable device. In particular, the work is transferred to, for example, to a receiver and then the personalized identification data is automatically embedded into the work.

It will be appreciated that more or fewer processes may be incorporated into the method illustrated in FIG. 8 without departing from the scope of the invention and that no particular order is implied by the arrangement of blocks shown and described herein. Skilled artisans will appreciate that the method described in conjunction with FIG. 8 may be embodied in machine-executable instructions (e.g., software). The instructions can be used to cause a general-purpose or special-purpose processor that is programmed with the instructions to perform the operations described. Alternatively, the operations may be performed by specific hardware components that contain hard-wired logic for performing the operations, or by any combination of programmed computer components and custom hardware components. The methods may be provided as a computer program product that may include a machine-readable medium having stored thereon instructions which may be used to program a computer (or other electronic devices) to perform the methods. For the purposes of this specification, the terms “machine-readable medium” includes any medium that is capable of storing or encoding a sequence of instructions for execution by the machine and that cause the machine to perform any one of the methodologies of the present invention. The term “machine-readable medium” includes, but is not be limited to, solid-state memories, optical and magnetic disks, and carrier wave signals. Furthermore, it is common in the art to speak of software, in one form or another (e.g., program, procedure, process, application, module, logic, etc.), as taking an action or causing a result. Such expressions are merely a shorthand way of saying that the execution of the software by a computer causes the processor of the computer to perform an action or a produce a result.

1. A method comprising:
embedding personalized identification data into a work before sending the work from a distributor over a communication link to a receiver; and
sending the work over the communication link to the receiver.

2. The method of claim 1 further comprising:
identifying an unauthorized copy of the work based upon the personalized identification data.

3. The method of claim 1 wherein the personalized identification data is in a watermark, wherein the watermark is one of a visible watermark and a hidden watermark.

4. The method of claim 1 wherein the embedding of the personalized identification data into the work occurs during real-time.

5. The method of claim 1 further comprising:
performing the embedding of the personalized identification data at the distributor by one of a head-end and a server.

6. The method of claim 1 further comprising:
recording a copy of the work onto a storage medium.

7. The method of claim 1 wherein the storage medium is a digital versatile disc.

8. The method of claim 1 wherein the personalized identification data includes a plurality of personal identifiers.

9. The method of claim 8 wherein the personalized identification data is one of a point of deployment (POD) identification number, a host identification number, a POD Mac address, an Internet protocol (IP) address, a name and address of a user.

10. The method of claim 1, wherein the work is one of an audiovisual work, an audio work, and a visual work.

11. A method comprising:
embedding a first identification data into a first audiovisual work before sending the first audiovisual work over a first communication link to a first receiver;
sending the first audiovisual work over the first communication link to the first receiver;
embedding a second identification data into a second audiovisual work before sending the second audiovisual work over a second communication link to a second receiver; and
sending the second audiovisual work over the second communication link to the second receiver, wherein the first audiovisual work and the second audiovisual work are substantially similar except the first identification data and the second identification data are different.

12. The method of claim 11 further comprising:
identifying an unauthorized copy of the first audiovisual work based upon the embedded first identification data.

13. The method of claim 11 further comprising:
embedding in real-time the first identification data into the first audiovisual work.

14. The method of claim 11 further comprising:
recording a copy of the first audiovisual work.

15. The method of claim 14 wherein the copy of the first audiovisual work is recorded onto one of a digital versatile disc and a video.

16. The method of claim 11 further comprising:
personalizing the first audiovisual work by including a screen that comprises a plurality of personal data elements.

17. The method of claim 11 further comprising:
polling the first receiver for the first identification data.

18. The method of claim 17 wherein the first identification data is one of a point of deployment (POD) identification number, a host identification number, a POD MAC address, and a POD Internet protocol (IP) address.

19. The method of claim 17 further comprising:
detecting an unauthorized copy of the first audiovisual work based upon a first identification data.

20. The method of claim 18 further comprising:
detecting an unauthorized dissemination of the first audiovisual work.

21. The method of claim 11 further comprising:
displaying at least a portion of the first personalized data on a graphical user interface (GUI) of the first receiver, wherein the first personalized data includes one of a name of a user and a date that the first audiovisual work was sent to the first receiver.

22. A method comprising:
embedding personal identification data related to a user into an audiovisual work before sending the audiovisual work over a network to a receiver;
sending the audiovisual work over the network to the receiver; and
identifying an unauthorized copy of the audiovisual work based upon the personal identification data.

23. An article comprising:
a storage medium including instructions stored thereon which, when executed, cause a computer system to perform a method including:
embedding personalized identification data related to a user into an audiovisual work before sending an audiovisual work over a communication link to a receiver; and
sending the audiovisual work over the communication link to the receiver.

24. The article of claim 23 wherein the computer system performs the method further comprising:
identifying an unauthorized copy of the audiovisual work based upon the personalized identification data.

25. The article of claim 23 wherein the personalized identification data is a watermark.

26. The article of claim 23 wherein the embedding of the personalized identification data occurs during real-time.

27. The article of claim 23 wherein performing the embedding of the personalized identification data occurs at one of a head-end and a receiver.

28. The article of claim 23 wherein the computer system performs the method further comprising:
recording a copy of the audiovisual work onto one of a digital versatile disc and a video.

29. The article of claim 23 wherein the personalized identification data includes a plurality of personal identifiers.

30. The article of claim 29 wherein the personalized identification data is one of a POD identification number, a host identification number, a POD Mac address, a POD IP address, and a name of a user.

31. A receiver for receiving a work comprising:
a memory for storing personal identification data; and
an embedder, coupled to the memory, for automatically embedding personal identification data into the work after the work is sent from a distributor and before the work is presented to a user of the receiver.

32. The receiver of claim 31 wherein the work is one of an audiovisual work, an audio work, and a visual work.

33. The receiver of claim 31 wherein the personalized data is one of a POD identification number, a host identification number, a POD Mac address, a POD IP address, and a name of a user.

34. The receiver of claim 31 wherein the personalized identification data in the work establishes an unauthorized copy of the work.

35. The receiver of claim 31 further comprising:
a GUI coupled to the memory, wherein the work displays on the GUI a screen with a name of a user.

36. A method comprising:
providing a first client;
coupling a work to the first client;
embedding personalized identification data into the work;
coupling a second client to the first client;
sending the work from the first client to the second client over a communication link.

37. The method of claim 36 further comprising:
identifying an unauthorized copy of the work based upon the personalized identification data.

38. A method comprising:
providing a client;
coupling a work to the client;
embedding in real-time personalized identification data into the work;
coupling a server to the client;
sending the work from the client to the server over a communication link.

39. The method of claim 38 further comprising:
identifying an unauthorized copy of the work based upon the personalized identification data.

40. The method of claim 39 wherein the personalized identification data includes a user's name.

41. A method comprising:
providing a server;
coupling a work to the server;
embedding in real-time personalized identification data into the work;
coupling a client to the server;
sending the work from the server to the client over a communication link.

42. The method of claim 41 further comprising:
identifying an unauthorized copy of the work based upon the personalized identification data.

43. The method of claim 41, wherein the personalized identification data includes a user's name.

44. The method of claim 41 wherein the work is one of an audiovisual work, an audio work, and a visual work.

45. The method of claim 44 wherein the audiovisual work is one of a computer program, a game, and a cartoon.

46. The method of claim 45 wherein the server personalizes at least one of a character in the cartoon before the work is sent to the client.

47. The method of claim 46 further comprising:
selling the work to a user of the client.
